(19) United States
(12) Patent Application Publication
(10) Pub. No.: US 2007/0163456 A1
(43) Pub. Date: Jul. 19, 2007

(54) FLEXOGRAPHIC PRINTING CYLINDER

(75) Inventors: Andreas Kuckelmann, Ibbenburen (DE); Wolfgang Brusdeilins, Bielefeld (DE); Bodo Steinmeier, Bielefeld (DE); Wilfried Tappe, Herford (DE)

Correspondence Address: RICHARD M. GOLDBERG, 25 EAST SALEM STREET, SUITE 419, HACKENSACK, NJ, 07601, US

(73) Assignees: FISCHER & KRECKE GMBH & CO. KG, Bielefeld (DE); INOMETA COATINGS GMBH, Herford (DE)

(21) Appl. No.: 11/622,151

(22) Filed: Jan. 11, 2007

(30) Foreign Application Priority Data
Jan. 13, 2006 (EP) 06 000 667.3

(51) Int. Cl. B41F 13/10

(52) U.S. Cl. 101/375

(57) ABSTRACT

A flexographic printing cylinder (10, 40) includes a cylinder body (20) made of a carbon fiber composite material and carrying a printing pattern on its peripheral surface (34), the printing pattern being formed by a polymer jacket layer (36) that is formed integrally with the cylinder body (20).

The present invention relates to a flexographic printing cylinder according to the preamble of claim 1.

Several types of printing cylinders are known for use in a flexographic print process. According to EP 1 025 996, the printing cylinder comprises a cylinder body that is made of a carbon fiber composite material and forms a self-supporting hollow cylinder which has its ends supported on a cylinder core by disks. This hollow cylinder carries printing blocks that form the printing pattern and are glued or clamped onto the peripheral surface of the hollow cylinder. This construction has the drawback that butting edges are formed at the positions where the edges of the printing blocks are butted together on the hollow cylinder. In the printing process, these butting edges disturb the smooth rotation of the printing cylinder and cause, for example, a so-called “bouncing”, i.e. an abrupt repression of an adjacent engaging cylinder when the butting edge passes through.

It has therefore been proposed to form the printing pattern directly on a sleeve that is thrust onto the printing cylinder and co-rotatably connected thereto. Sleeves, as they are shown for example in EP 0 787 597 A2, comprise a rigid base and additional layers formed thereon. In contrast to conventional constructions wherein a printing block forming the printing pattern has to be mounted on the sleeve, a further development has the feature that the outer layer of the sleeve is treated in a photo-polymeric process or gravure process, so that it may itself form the printing pattern. Although butting edges on the surface can be avoided in this way, it is necessary, in order to achieve a snug fit on the printing cylinder and optimal running properties, to employ a complex layer structure including elastic layers or an adapter that is interposed between the sleeve and the surface of the printing cylinder core. As a result, the construction of the printing cylinder as a whole becomes relatively intricate.

It is therefore an object of the present invention to provide a printing cylinder of the type indicated above, which has optimal running properties and nevertheless has a relatively simple construction.

According to the invention, this object is achieved by a printing cylinder having the features indicated in claim 1.

The printing cylinder according to the invention comprises a jacket layer that is made of a polymer and is formed integrally with the cylinder body. It is this jacket layer that forms the printing pattern and can be treated by laser gravure or by photopolymeric methods, for example, to that end. When a material with suitable rebound properties is selected for the surface layer, vibrations that are generated during the rotation of the printing cylinder are attenuated, and the running properties are improved. The use of sleeves having a complex layer structure, adapter sleeves and the like can be dispensed with completely, so that the overall construction is simplified significantly.

Useful details of the invention are indicated in the dependent claims.

A preferred embodiment of the invention will now be explained in conjunction with the drawings, wherein:

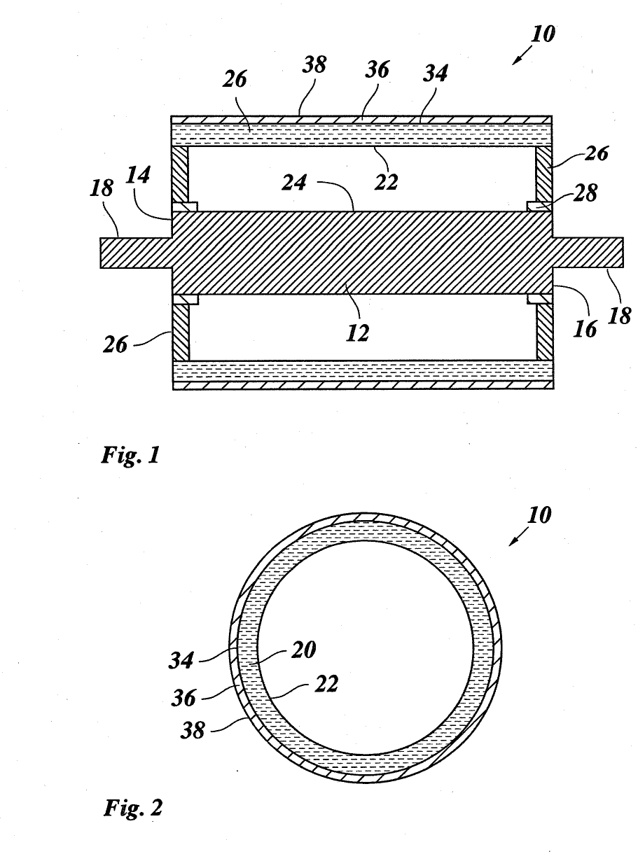

FIG. 1 shows a longitudinal sectional view of an embodiment of a printing cylinder according to the invention;

FIG. 2 shows a cross-section of the printing cylinder according to FIG. 1; and

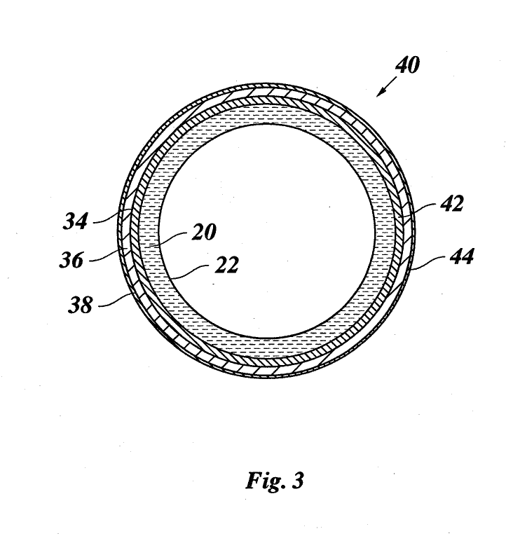

FIG. 3 shows a cross-section of a printing cylinder according to another embodiment of the invention.

The printing cylinder 10 shown in FIG. 1 comprises a cylinder core 12 that is made of steel and is provided at its both ends with axle studs 18 projecting from the end faces 14, 16 of the cylinder core for supporting the same in a machine frame. Further, the printing cylinder 10 comprises a cylinder body 20 that is formed by a hollow cylindrical body that is made of carbon fiber composite material and coaxially surrounds the cylinder core 12 and is spaced therefrom. The carbon fiber composite material of the cylinder body 20 may for example be a framework of diagonally wound carbon fibers that are embedded in a matrix of synthetic resin.

The internal surface 22 of the cylinder body 20 is held at a spacing from the outer peripheral surface 24 of the cylinder core by means of flat disks 26 that are thrust onto the ends of the cylinder core 12 and are clamped thereon in a rotationally rigid manner. This releasable clamping is achieved by hydraulically expandable bushings 28 on the cylinder core 12, as is described for example in DE 33 09 815 A1. In the drawing, the clamping units have only been shown in simplified form for reasons of clarity.

The cylinder body 20 itself is also connected with its internal surface 22 to the disks 22 without play and in a rotationally rigid manner, so that the cylinder core 12, the disks 26 and the cylinder body 20 form a rotationally rigid unit. This construction is essentially known from EP 1 025 996 A1.

On its outer peripheral surface 34, the cylinder body 20 carries a radially outer jacket layer 36 that is formed integrally with the cylinder body 20, i.e. which may be molded on the peripheral surface 34 by a suitable process, so that the cylinder body 20 and the jacket layer 36 form an integral unit. The jacket layer 36 consists of a polymer and forms the printing pattern of the printing cylinder 10. To that end, the outer peripheral surface 38 of the jacket layer 36, which here forms the outer peripheral surface of the printing cylinder 10, has been treated in a suitable manner, e.g. by a gravure treatment such as laser gravure or by a photopolymeric process in which a photopolymer forming the jacket layer 36 is exposed with light, and the non-exposed areas are removed chemically. When a gravure process is employed, rubber, for example, may also be a suitable material for the jacket layer 36.

In order to achieve good running properties of the printing cylinder 10, the material of the jacket layer 36 preferably has a suitable rebounding elasticity, so that the jacket layer 36 may absorb and attenuate vibrations and shocks that are transmitted from an adjacent roller that is set against the outer peripheral surface 38 of the printing cylinder 10. Thus, the printing cylinder 10 according to the invention combines the advantages of a comparatively simple construction with good running properties. As a modification of the construction shown in FIG. 1, it is also possible to employ, for example, a massive cylinder body and to dispense with the internal structure that has been shown in FIG. 1 and comprises a cylinder core 12 and disks 26 as spacers.

In FIG. 2, the cylinder body 20 and the jacket layer 36 formed thereon are shown in a cross-sectional view, whereas the internal structure of the printing cylinder 10, i.e. the cylinder core 12 and the disks 26, have not been shown. Intermediate layers may be provided between the peripheral surface 34 of the cylinder body 20 and the jacket layer 36, as has been shown in cross-section for a printing cylinder 40 in FIG. 3. The intermediate layer 42 shown therein is also made of a polymer which, however, is softer than the polymer of the jacket layer 36. This permits to further improve the running properties of the printing cylinder 10. Moreover, a thin protective layer 44 is formed on the outer peripheral surface 38 of the jacket layer 36, for protecting the jacket layer 36 against damage without degrading the surface structure and the printing properties thereof.

When the printing pattern is to be changed, the jacket layer 36 and the further layers 42, 44, if present, may be ablated from the cylinder body 20 by milling, so that the peripheral surface 34 is exposed again and a new jacket layer 36 may be applied which will then be transformed into a new printing pattern by a gravure or photopolymeric process.

1. A flexographic printing cylinder comprising:
a cylinder body made of a carbon fiber composite material,
a polymer jacket layer that is formed integrally with and on a peripheral surface of the cylinder body, the polymer jacket layer including a printing pattern thereon.

2. The printing cylinder according to claim 1, wherein the jacket layer carries a printing pattern formed by laser gravure.

3. The printing cylinder according to claim 1, wherein the jacket layer is made of rubber.

4. The printing cylinder according to claim 1, wherein the jacket layer is made of a photo-polymer.

5. The printing cylinder according to claim 1, further comprising at least one intermediate layer interposed between the peripheral surface of the cylinder body and the jacket layer.

6. The printing cylinder according to claim 5, wherein the intermediate layer is made of a material that is softer than the jacket layer.

7. The printing cylinder according to claim 1, further comprising a protective layer formed on a peripheral surface of the jacket layer.

8. The printing cylinder according to claim 1, wherein the cylinder body is a hollow cylindrical body that coaxially surrounds a cylinder core and is releasably clamped thereon without play and in a rotationally rigid manner.
